(19) United States
(12) Patent Application Publication
(10) Pub. No.: US 2023/0213759 A1
(43) Pub. Date: Jul. 6, 2023

(54) Flexible Optical Apparatus To Extend Effective Aperture Of Collimator For AR/VR Binocular Alignment

(71) Applicant: MLOptic Corp, Redmond, WA (US)

(72) Inventors: Wei Zhou, Sammamish, WA (US); Jiang He, Nanjing (CN); Siyuan Liang, Nanjing (CN); Huayu Gu, Nanjing (CN)

(21) Appl. No.: 17/565,575

(22) Filed: Dec. 30, 2021

(51) Int. Cl. G02B 27/01; G02B 27/14

(52) U.S. Cl. CPC G02B 27/0172; G02B 27/14; G02B 2027/0136; G02B 2027/0198

(57) ABSTRACT

A system for extending the effective aperture of an optical output in a direction parallel to the optical axis of the optical output, the system including a beam splitter configured for receiving an output beam of the optical output along the optical axis of the optical output, the beam splitter configured for splitting the output beam into two light beams; a central mirror for receiving and directing a first of the two light beams from the beam splitter; and a pair of motorized mirrors each motorized mirror including a mobility mechanism and a mirror functionally connected to the mobility mechanism, each of the motorized mirrors is configured to be movable in a direction orthogonal to the optical axis, wherein the optical output is extended to the two light beams separated by a pupil distance adjustable by controlling at least a mobility mechanism of one of the pair of motorized mirrors.

### BACKGROUND OF THE INVENTION

### 1. The Field of the Invention

The present invention relates to a flexible optical apparatus to extend the effective aperture of an optical output for AR/VR binocular alignments. More specifically, the present invention is directed to a flexible optical apparatus that allows an external entrance pupil to be projected at two different spots simultaneously in order to extend the effective aperture of an optical output for AR/VR binocular alignments.

### 2. Background Art

Product performance testing of Augmented Reality/Virtual Reality (AR/VR) glasses requires the help of photoelectric autocollimators or large-aperture collimators to provide infinite and limited distance target sources, generally covering −4D˜0D˜+0.8D, i.e., −250 mm˜infinity˜+1300 mm. The interpupillary distance (IPD) of a general adult is between 60 mm and 75 mm and the image projection module is arranged at the outer end close to the human ear and its exit pupil distance is between 110-135 mm considering the above two test scenarios. The IPD of the test device needs to cover a width of 60 mm˜135 mm.

A photoelectric autocollimator is an important instrument for small-angle measurements. Its theoretical basis is the principle of optical autocollimation. It is mostly used in the field of precision measurement. The effective clear aperture of a commercial photoelectric autocollimator currently on the market measures no more than 100 mm. Although the collimator can achieve a relatively large diameter due to chromatic aberration and the size of the glass material, the large diameter collimator generally adopts a reflective small field of view off-axis parabola or a refraction glass objective lens group. The manufacturing cost of a large-aperture collimator is very high and the collimator cannot provide a target source with a limited distance except for an infinite target source. In the process of AR and VR virtual reality display equipment performance detection process, a target source with a large pupil distance and a wide object distance range is required. General autocollimators cannot provide large-aperture beams and wide object distances. The challenge of the range lies in the need for providing a target source that can expand the interpupillary distance. The distance between the exit pupils needs to be about 60 mm-200 mm.

There exists a need for a system for providing infinite and finite object distance target sources without the high costs and a system that allows an external entrance pupil to be projected at two different spots simultaneously in order to extend the effective aperture of an optical output for AR/VR binocular alignments.

### SUMMARY OF THE INVENTION

In accordance with the present invention, there is provided a system for extending the effective aperture of an optical output in a direction parallel to the optical axis of the optical output, the system including:

(a) a beam splitter configured for receiving an output beam of the optical output along the optical axis of the optical output, the beam splitter configured for splitting the output beam into two light beams;

(b) a central mirror for receiving and directing a first of the two light beams from the beam splitter; and

(c) a pair of motorized mirrors each motorized mirror including a mobility mechanism and a mirror functionally connected to the mobility mechanism, each of the motorized mirrors is configured to be movable in a direction orthogonal to the optical axis, a first of the pair of motorized mirrors is configured to receive the first of the two light beams from the central mirror and direct the first of the two light beams in a direction parallel to the optical axis of the optical output and a second of the pair of motorized mirrors is configured to receive the second of the two light beams from the beam splitter and direct the second of the two light beams in a direction parallel to the optical axis of the optical output,

wherein the optical output is extended to the two light beams separated by a pupil distance adjustable by controlling at least a mobility mechanism of one of the pair of motorized mirrors.

In one embodiment, one of the two light beams is reflected and the other one of the two light beams is transmitted at the beam splitter.

There is further provided a system for extending the effective aperture of an optical output in a direction parallel to the optical axis of the optical output, the system including:
(a) a beam splitter configured for receiving an output beam of the optical output along the optical axis of the optical output, the beam splitter configured for splitting the output beam into two light beams; and
(b) a pair of motorized mirrors each motorized mirror including a mobility mechanism and a mirror functionally connected to the mobility, each of the motorized mirrors is configured to be movable in a direction orthogonal to the optical axis, a first of the pair of motorized mirrors is configured to receive the first of the two light beams from the beam splitter and direct the first of the two light beams in a direction parallel to the optical axis of the optical output and a second of the pair of motorized mirrors is configured to receive the second of the two light beams from the beam splitter and direct the second of the two light beams in a direction parallel to the optical axis of the optical output,

wherein the optical output is extended to the two light beams separated a pupil distance adjustable by controlling at least a mobility mechanism of one of the pair of motorized mirrors.

In one embodiment, the two light beams are pointing in opposite directions of one another at the beam splitter. In one embodiment, the beam splitter is a beam splitter configured for splitting the optical output into two light beams pointing in opposite directions of one another. In one embodiment, the pupil distance is a distance of about 60-200 mm. In one embodiment, the optical output are light beams of a collimated light source, a convergent light source or a divergent light source.

An object of the present invention is to provide a system that extends the effective aperture of an optical output to two light beams so that a pair of AR/VR glasses can be aligned.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a system layout with a pupil distance of 200 mm.

FIG. 2 depicts a system layout with a 60 mm interpupillary distance (IPD).

FIG. 3 depicts a system layout with a pupil distance of 200 mm.

FIG. 4 depicts a system layout with a 60 mm IPD.

FIG. 5 depicts an MTF curve of an infinite object distance auto-collimation module.

FIG. 6 depicts a 1300 mm object distance auto-collimation module MTF curve.

FIG. 7 depicts an MTF curve of a 250 mm object distance auto-collimation module.

FIG. 8 depicts a spot diagram of an infinite object distance auto-collimation module.

FIG. 9 depicts a 1300 mm object distance auto-collimation module spot diagram.

FIG. 10 depicts a spot diagram of a 250 mm object distance auto-collimation module.

FIG. 11 depicts the corresponding curve between the object distance and the position of a reticle.

### PARTS LIST

2—LED light source
4—LED collimator lens group
6—LED collimator lens group
8—uniform light use astigmatism film
10—reticle
12—relay lens
14—relay lens
16—physical diaphragm
18—lens group
20—lens group
22—imaging lens group
24—imaging lens group
26—imaging lens group
28—imaging lens group
30—imaging lens group
32—imaging lens group
34—beam splitter, e.g., dichroic prism
36—mirror
38—position
40—mirror
42—mirror
44—position
46—beam splitter, e.g., Cross (X)-cube dichroic prism
48—beam splitter
50—imaging detector
52—front group
54—back or rear group
56—target source generator
58—relay lens group
60—self-collimating lens group
62—Augmented Reality/Virtual Reality (AR/VR) glass
64—optical output
66—light beam
68—light beam
70—optical axis of optical output

### PARTICULAR ADVANTAGES OF THE INVENTION

The present flexible optical apparatus that allows an external entrance pupil to be projected at two different spots simultaneously in order to extend the effective aperture of an optical output for AR/VR binocular alignments. Therefore, testing does not need to be performed on each spot individually, as the single optical output is split into two beams spread apart a distance that is adjustable.

The present flexible optical apparatus that allows the interpupillary distance (IPD) to be adjusted. It is therefore suitable for use in AR/VR binocular alignments as two light beams are required. As there are two light beams, the need for a large single optical output can be avoided.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

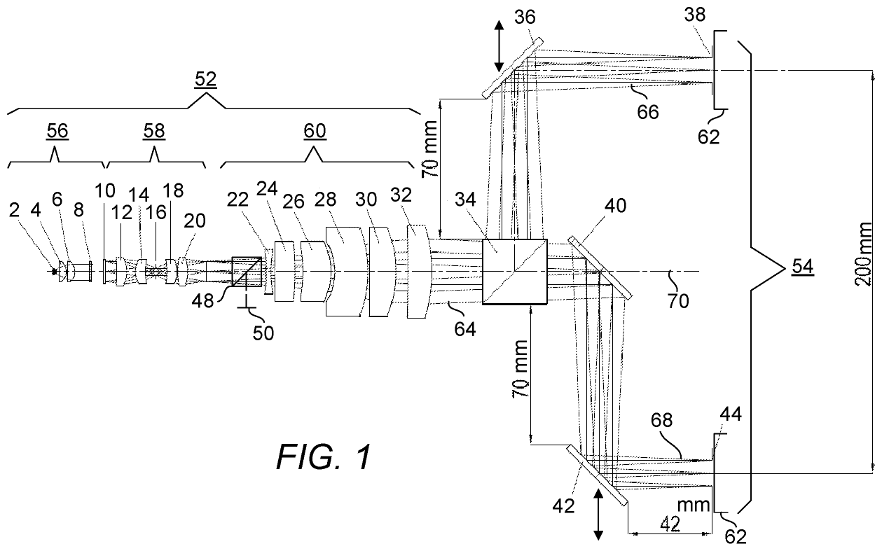

Disclosed herein is a system for extending the effective aperture of an optical output in a direction parallel to the optical axis 70 of the optical output. Target sources or light beams with an expandable interpupillary distance (IPD) are provided. In one example, the test range of the IPD is expanded by moving the distance between two mirrors and the position of a reticle of the system causing the optical output to be moved axially to provide −250 mm˜Infinity˜+1300 mm target source distance range. In general, a specific light path system that provides infinite and finite object distance target sources and expands the pupil distance at the same time includes two parts, i.e., the front group 52 and the back group 54 shown in FIG. 1. FIG. 1 depicts a system layout with a pupil distance of about 200 mm. In one example, the front group 52 includes a target source generator 56, a relay lens group 58 and an autocollimator lens group 60. The target source generator 56 includes LED light source 2, LED collimator lens groups 4, 6, uniform light use astigmatism film 8 and reticle 10. The relay lens group 58 includes a relay lens 12, a relay lens 14, a physical diaphragm 16, a relay lens 18 and a relay lens 20. The self-collimating module 60 includes an imaging lens group 22 to 32, a beam splitting prism 48 and an imaging detector 50. With lens groups 18 and 20, the autocollimator group 60 and the rear group 54, the physical diaphragm can be imaged to positions 38 and 44, which becomes a virtual diaphragm and is convenient for splicing with the pupil of the glasses 62 under test.

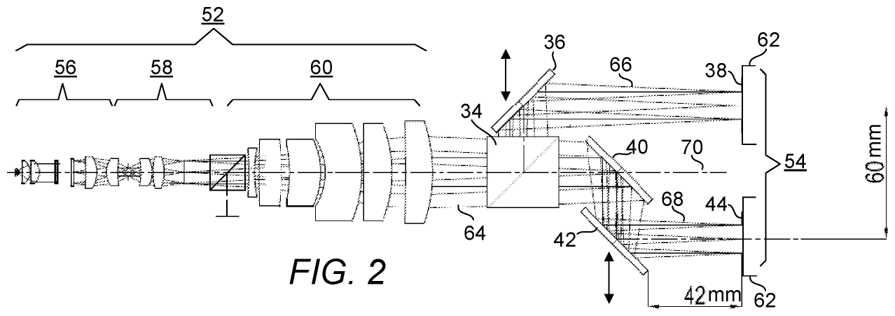

In one embodiment, the rear group 54 includes a dichroic prism 34 and three 45° placed mirrors 36, 40, and 42 although a dichroic prism is not required. In its place, a beam splitter is suitable for splitting the optical output 64 into two light beams or target sources. FIG. 2 depicts a system layout with a 60 mm interpupillary distance (IPD). Adjustments to the alignment of the AR/VR glasses can then be made given the light beams projected to the AR/VR glasses 62. Therefore, the interval between the moving mirrors 36 and 42 through motor control covers the IPD pupil distance where it is configured to be about 60 mm-200 mm and the present motorized mirrors are configured to be capable of assuming positions that generate light beams or target sources at these IPDs.

As disclosed elsewhere herein, the present system includes a beam splitter 34, a central mirror 40 or a mirror disposed along the optical axis 70 of the optical input of the beam splitter 34 and adjacent the beam splitter 34, and a pair of motorized mirrors 36, 42. The beam splitter 34 is configured for receiving an output beam of the optical output 64 along the optical axis 70 of the collimator, the beam splitter configured for splitting the output beam into two light beams 66, 68. The central mirror 40 is configured for receiving and directing a first of the two light beams 66, 68 or target sources, from the beam splitter 34. Each of the motorized mirrors 36, 42 includes a mobility mechanism, e.g., equipped with motors, solenoids, gears and racks, etc., and a mirror functionally connected to the mobility mechanism. Each of the motorized mirrors 36, 42 is configured to be movable in a direction orthogonal to the optical axis of the optical output. The first of the pair of motorized mirrors is configured to receive the first of the two light beams 66, 68 from the central mirror 40 and direct the first of the two light beams in a direction parallel to the optical axis 70 of the optical output. The second of the pair of motorized mirrors 36, 42 is configured to receive the second of the two light beams from the beam splitter and direct the second of the two light beams in a direction parallel to the optical axis of the optical output. The optical output 64 of the optical lens groups upstream of the beam splitter 34 is extended to the two light beams 66, 68 disposed a pupil distance apart where the pupil distance is adjustable by controlling at least a mobility mechanism of one of the pair of motorized mirrors 36, 42.

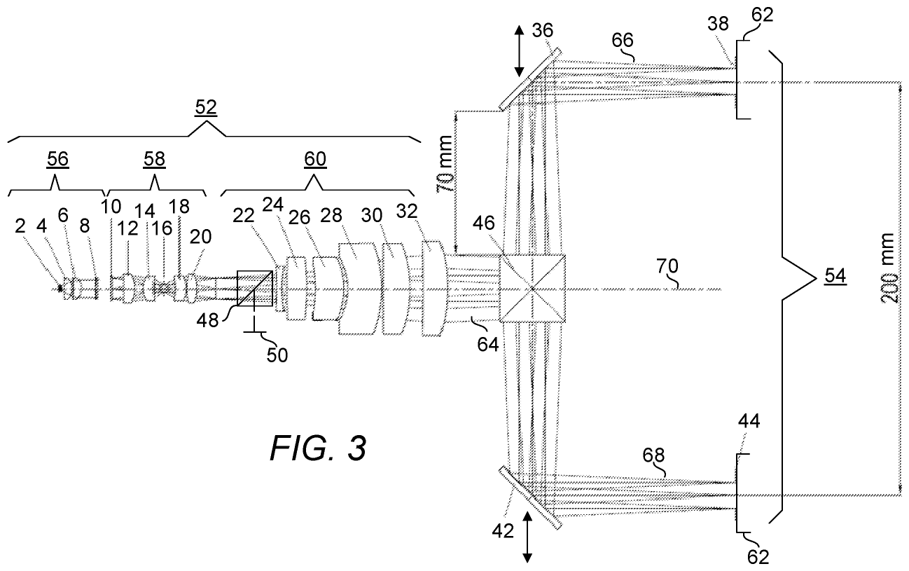

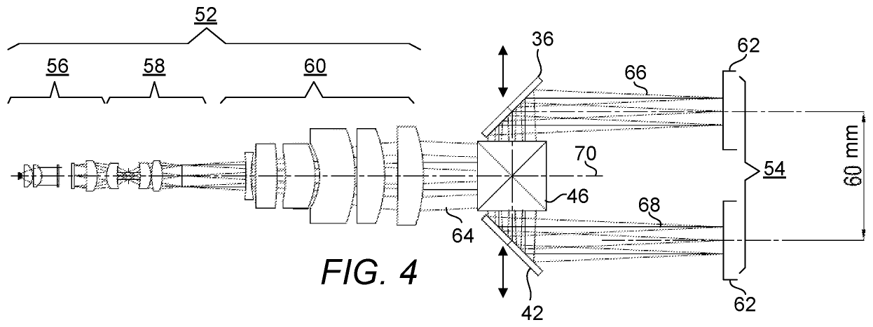

Disclosed herein again, in FIGS. 3 and 4, is a system for extending the effective aperture of an optical output in a direction parallel to the optical axis of the optical output 64. Again, FIG. 3 depicts a system layout with a pupil distance of 200 mm. FIG. 4 depicts a system layout with a 60 mm IPD. Note the difference between the system of FIGS. 1 and 2 and the system of FIGS. 3 and 4. In the system shown in FIGS. 3 and 4, the system lacks a central mirror as in the case of FIGS. 1 and 2. The beam splitter 46 is configured for receiving an output beam of the optical output 64 along the optical axis of the optical output or another optical lens group, the beam splitter 46 configured for splitting the output beam into two light beams 66, 68. Each of the pair of motorized mirrors 36, 42 includes a mobility mechanism and a mirror functionally connected to the mobility. Each of the motorized mirrors 36, 42 is configured to be movable in a direction orthogonal to the optical axis, a first of the pair of motorized mirrors is configured to receive the first of the two light beams from the beam splitter and direct the first of the two light beams in a direction parallel to the optical axis of the optical output and a second of the pair of motorized mirrors is configured to receive the second of the two light beams from the beam splitter and direct the second of the two light beams in a direction parallel to the optical axis 70 of the optical output. The optical output is extended to the two light beams 66, 68 separated by a pupil distance adjustable by controlling at least a mobility mechanism of one of the pair of motorized mirrors 36, 42.

In this embodiment, the two light beams 66, 68 are pointing in opposite directions of one another at the beam splitter 46. The beam splitter 46 is a beam splitter configured for splitting the optical output into two light beams pointing in opposite directions of one another. Although the optical output is shown as collimated light beams, light beams of other types of optical output can also be used, e.g., light beams of a convergent light source or a divergent light source. With the use of beam splitter 46 as shown in FIGS. 3 and 4, energy utilization can be reduced by 50% although the beam splitter 46 is less efficient. In one embodiment, the beam splitter 46 is a Cross (X)-cube dichroic prism or simply X dichroic prism.

Referring back to FIGS. 1-4, in order to achieve different object distances under a certain exit pupil distance, the target source group and relay group, beam splitter 48 and imaging detector 50 are fixed on the same electric platform and moved along the axial direction. The provided object distance satisfies Newton's imaging formula. The exit pupil distance IPD can be changed by moving the interval between mirror 36 and mirror 42. The target source distance range −250 mm˜Infinity˜+1300 mm can be achieved by moving the distance between the reticle and the auto-collimation module. The diameter of the required lens in the system is less than 50 mm and the processing difficulty and manufacturing cost are relatively low.

Table 1 lists system parameters of the entire system shown in FIGS. 1-4. The system includes two parts, i.e., the front group 52 and the back group 54. The front group 52 includes the target source generator 56, the relay lens group 58 and the self-collimating lens group 60. The target source generator 56 includes an LED light source 2, an LED collimating lens group and a collimating lens group 6, a uniform light astigmatism sheet 8 and a reticle 10. The relay lens group 58 includes a relay lens 12, a relay lens 14, a physical diaphragm 16, a relay lens 18 and a relay lens 20. The self-collimating lens group 60 includes an imaging lens group 22 to 32, a beam splitting prism 48 and an imaging detector 50.

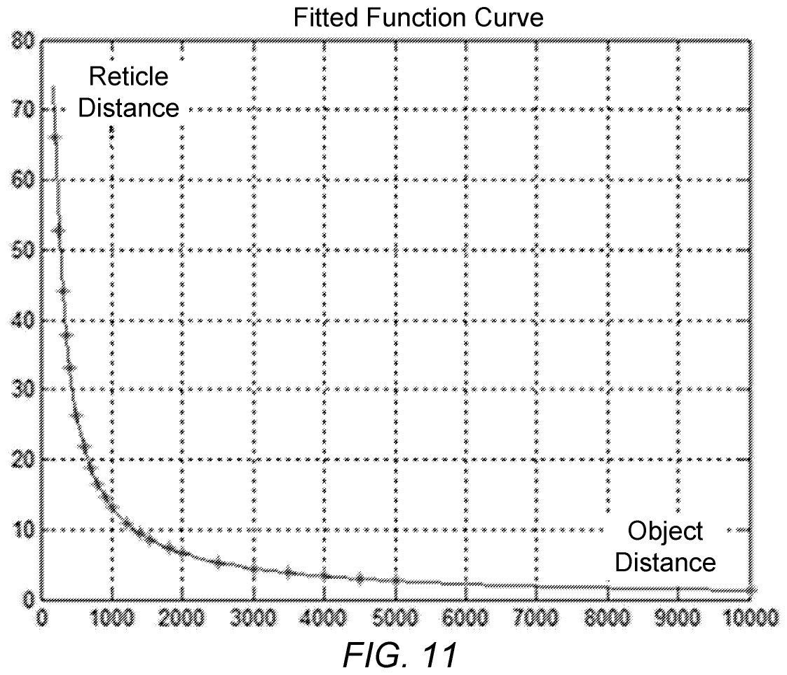

Table 2 shows the parameters of all lenses with a radius of curvature in the specific embodiment. With the lens groups 18 and 20, the autocollimator group 60 and the rear group 54, the physical diaphragm can be imaged to positions 38 and 44, which becomes a virtual diaphragm, which is convenient for splicing with the pupil of the glasses under test. In one example, the rear group 54 includes a dichroic prism 34 and three 45° placed mirrors 36, 40 and 42. The interval between the moving mirrors 36 and 42 through motor control covers the IPD pupil distance range from about 60 mm-200 mm. In order to achieve different object distances under a certain exit pupil distance, the target source group and relay group, beam splitter 48 and imaging detector 50 are fixed on the same electric platform and moved along the axial direction. The provided object distance satisfies Newton's imaging formula as shown in Table 3 and FIG. 11.

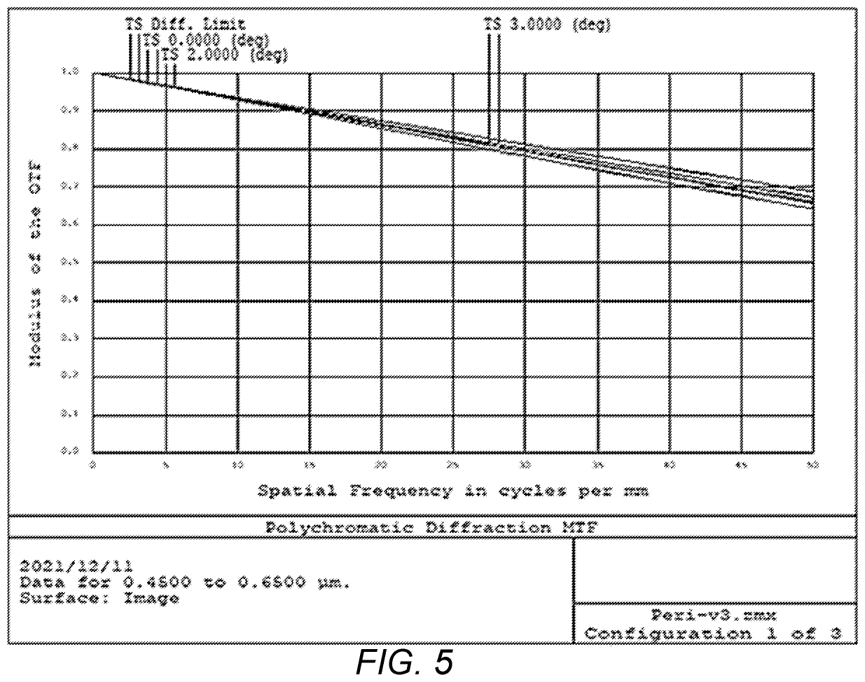

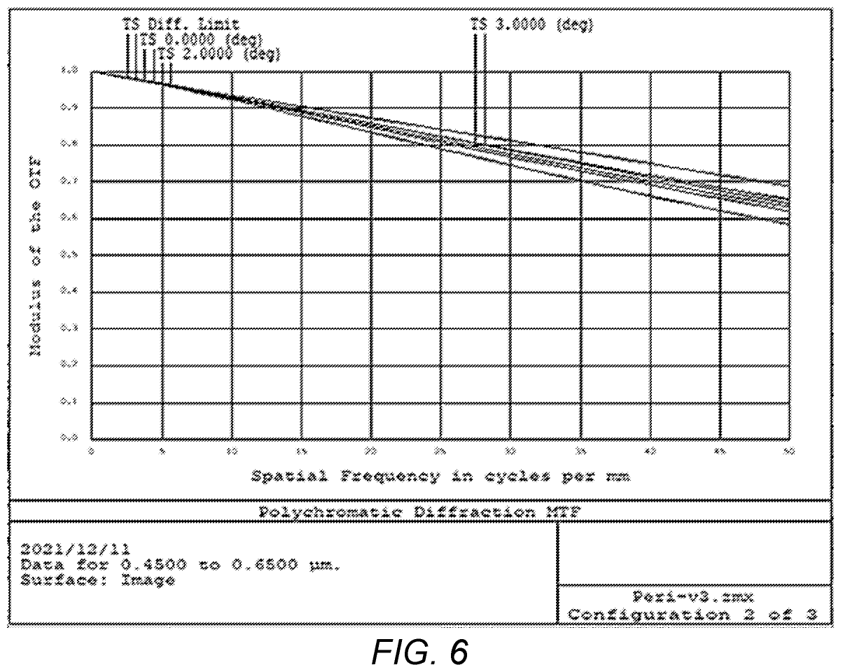

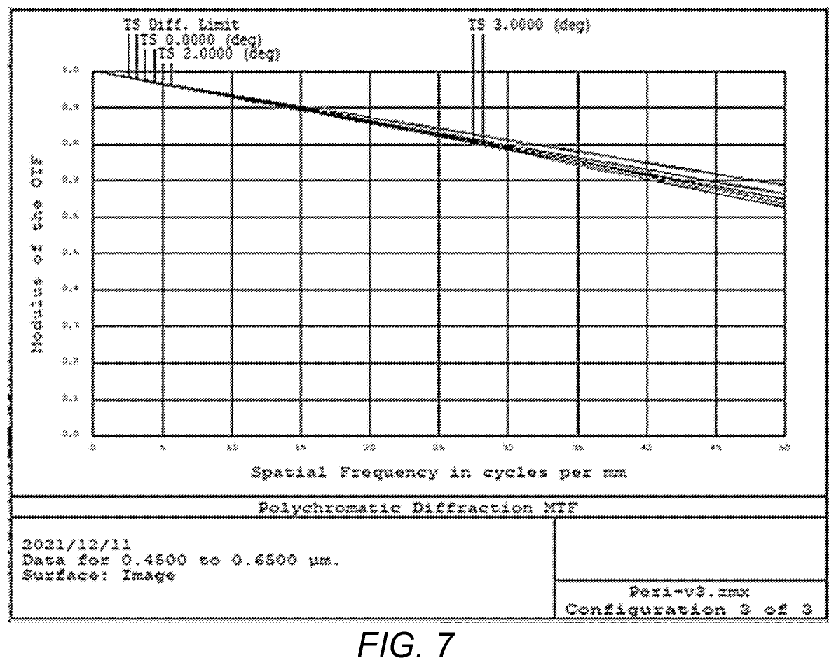

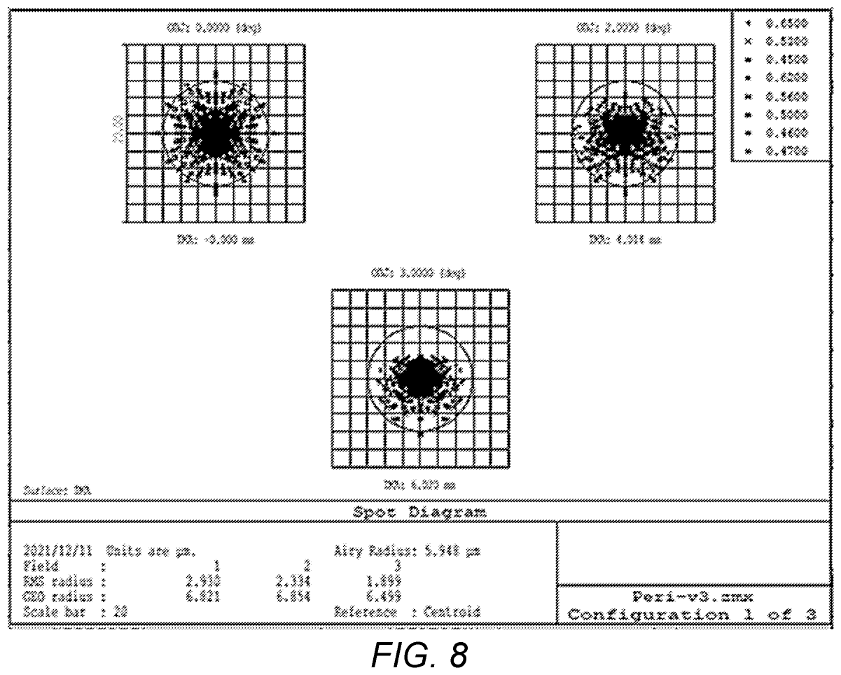

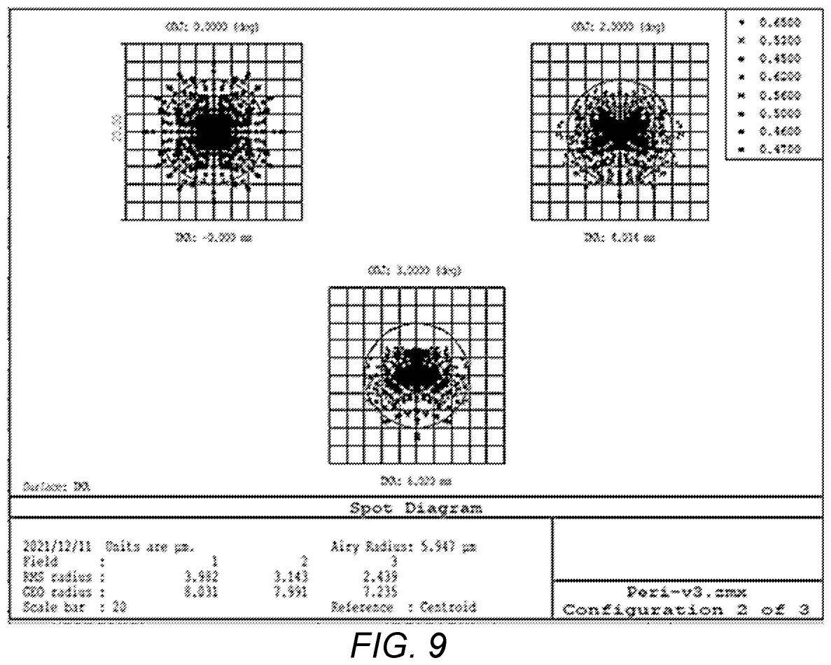

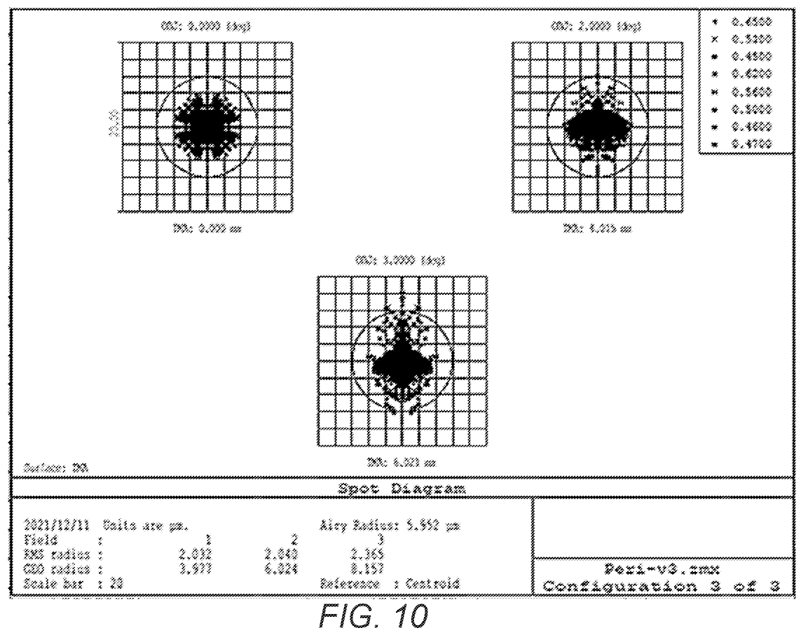

FIGS. 5, 6 and 7 show the MTF curves of the self-collimating module 60 at infinite object distance, −1300 mm and 250 mm. FIGS. 8, 9, and 10 show the MTF curves of the self-collimating module 60 at infinite object distance, −1300 mm and 250 mm spot pattern, with the image quality essentially reaching the diffraction limit.

TABLE 1
System indicators

| Wave band | 450-650 | nm |
|---|---|---|
| Relay group 58 magnification | 1X | |
| Focal length of self-collimating lens | 115 | mm |
| Solid diaphragm 36 | 3.4 | mm |
| Virtual diaphragm 38\44 | 12.5 | mm |
| Interpupillary distance IPD range | 60-200 | mm |

| | |
|---|---|
| Object distance range | −1300 mm~infinite~+250 mm |

TABLE 2
Lens parameters

| | | Radius of | Thickness | | Abbe |
|---|---|---|---|---|---|
| Part | | curvature | or interval | Index of | number |
| Number | Type | (mm) | (mm) | refraction | γ |
| 4 | spheric surface | infinity | 4 | 1.516 | 64.2 |
| | spheric surface | −6.5 | 0.3 | | |
| 6 | spheric surface | infinity | 4 | 1.516 | 64.2 |
| | spheric surface | −6.5 | 20 | | |
| 12 | spheric surface | −151.91 | 5 | 1.517 | 64.2 |
| | spheric surface | −13.70 | 4.18 | | |
| 14 | spheric surface | 10.10 | 5 | 1.755 | 27.5 |
| | spheric surface | 33.12 | 5.116 | | |
| 16 | spheric surface | infinity | 5.57 | | |
| 18 | spheric surface | −33.12 | 5 | 1.755 | 27.5 |
| | spheric surface | −12.22 | 0.3 | | |
| 20 | spheric surface | 27.08 | 5 | 1.517 | 64.2 |
| | spheric surface | −18.27 | 19.13 | | |
| 22 | spheric surface | −149.8 | 2.5 | 1.743 | 49.2 |
| | spheric surface | 56.78 | 2 | | |
| 24 | spheric surface | 527.6 | 10 | 1.846 | 23.8 |
| | spheric surface | −131.8 | 3.84 | | |
| 26 | spheric surface | −67.1 | 13 | 1.723 | 37.9 |
| | spheric surface | −31.8 | 2 | | |
| 28 | spheric surface | −25.2 | 15 | 1.623 | 36.3 |
| | spheric surface | −59.9 | 0.8 | | |
| 30 | spheric surface | infinity | 13 | 1.497 | 81.6 |
| | spheric surface | −79.5 | 5.96 | | |
| 32 | spheric surface | −1000 | 12 | 1.516 | 64.2 |
| | spheric surface | −94 | 20 | | |

TABLE 3
Relationship between the position of
the reticle and the working distance

| | Reticle distance | Working distance |
|---|---|---|
| No. | (mm) | (m) |
| 1 | 82.417 | 0.25 |
| 2 | 56.012 | 0.5 |
| 3 | 42.817 | 1 |
| 4 | 40.618 | 1.2 |
| 5 | 38.191 | 1.54 |
| 6 | 36.22 | 2 |
| 7 | 32.263 | 5 |
| 8 | 30.944 | 10 |
| 9 | 29.625 | Infinity |
| 10 | 28.306 | −10 |
| 11 | 26.986 | −5 |
| 12 | 23.029 | −2 |
| 13 | 21.381 | −1.6 |
| 14 | 19.478 | −1.3 |

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A system for extending the effective aperture of an optical output in a direction parallel to the optical axis of the optical output, said system comprising:
(a) a beam splitter configured for receiving an output beam of the optical output along the optical axis of the optical ouput, said beam splitter configured for splitting said output beam into two light beams;
(b) a central mirror for receiving and directing a first of said two light beams from said beam splitter; and
(c) a pair of motorized mirrors each motorized mirror comprising a mobility mechanism and a mirror functionally connected to said mobility mechanism, said each motorized mirror configured to be movable in a direction orthogonal to said optical axis, a first of said pair of motorized mirrors is configured to receive said first of said two light beams from said central mirror and direct said first of said two light beams in a direction parallel to the optical axis of the optical output and a second of said pair of motorized mirrors is configured to receive said second of said two light beams from said beam splitter and direct said second of said two light beams in a direction parallel to the optical axis of the optical output,
wherein the optical output is extended to said two light beams separated by a pupil distance adjustable by controlling at least a mobility mechanism of one of said pair of motorized mirrors.

2. The system of claim 1, wherein said pupil distance is a distance of about 60-200 mm.

3. The system of claim 1, wherein one of said two light beams is reflected and the other one of said two light beams is transmitted at said beam splitter.

4. The system of claim 1, wherein said optical output are light beams selected from the group consisting of a collimated light source, a convergent light source and a divergent light source.

5. A system for extending the effective aperture of an optical output in a direction parallel to the optical axis of the optical output, said system comprising:
(a) a beam splitter configured for receiving an output beam of the optical output along the optical axis of the optical output, said beam splitter configured for splitting said output beam into two light beams; and
(b) a pair of motorized mirrors each motorized mirror comprising a mobility mechanism and a mirror functionally connected to said mobility, said each motorized mirror configured to be movable in a direction orthogonal to said optical axis, a first of said pair of motorized mirrors is configured to receive said first of said two light beams from said beam splitter and direct said first of said two light beams in a direction parallel to the optical axis of the optical output and a second of said pair of motorized mirrors is configured to receive said second of said two light beams from said beam splitter and direct said second of said two light beams in a direction parallel to the optical axis of the optical output,
wherein the optical output is extended to said two light beams separated by a pupil distance adjustable by controlling at least a mobility mechanism of one of said pair of motorized mirrors.

6. The system of claim 5, wherein said two light beams are pointing in opposite directions of one another at said beam splitter.

7. The system of claim 5, wherein said beam splitter is a beam splitter configured for splitting the optical output into two light beams pointing in opposite directions of one another.

8. The system of claim 5, wherein said pupil distance is a distance of about 60-200 mm.

9. The system of claim 5, wherein said optical output are light beams selected from the group consisting of a collimated light source, a convergent light source and a divergent light source.
